(19) United States
(12) Patent Application Publication
(10) Pub. No.: US 2014/0025407 A1
(43) Pub. Date: Jan. 23, 2014

(54) CUSTOMER RESERVATION AUCTION SYSTEM

(71) Applicant: Brian Hayek, San Diego, CA (US)

(72) Inventor: Brian Hayek, San Diego, CA (US)

(21) Appl. No.: 13/943,614

(22) Filed: Jul. 16, 2013

Related U.S. Application Data
(60) Provisional application No. 61/673,130, filed on Jul. 18, 2012.

(51) Int. Cl. G06Q 50/12; G06Q 10/02

(52) U.S. Cl. CPC G06Q 50/12; G06Q 10/02
USPC 705/5

(57) ABSTRACT

In one aspect, there is provided a method. The method may include selecting, by a user equipment, an establishment participating in an auction for a reservation of a table made available by the establishment; receiving, by the user equipment, bid information including at least one of a current bid or a minimum bid for the auction for the reservation of the table, when the auction begins; sending, by the user equipment, a bid to an auction system, the bid sent in response to the receiving bid information; and receiving, by the user equipment, an indication provided by the auction system, the indication representative of whether the user equipment won or lost the auction for the reservation of the table. Related systems, methods, and articles of manufacture are also disclosed.

### CROSS REFERENCE TO RELATED APPLICATIONS

This application claims priority under 35 U.S.C 119(e) to U.S. Provisional Patent Application Ser. No. 61/673,130, filed Jul. 18, 2012, titled, “Customer Reservation Auction System.” Priority of the filing date of the Provisional Patent Application is hereby claimed. The disclosure of the Provisional Patent Application is incorporated by reference herein in its entirety.

### TECHNICAL FIELD

The subject matter described herein relates generally to data processing and, in particular, scheduling reservations with prioritization.

### BACKGROUND

An auction refers to a sale of property to typically the highest bidder. Often these auctions are done online via the Internet. There are numerous types of auction. For example, during an open-ascending-price-auction, bidders openly bid against each other using a higher bid than a prior bid. The auction may be closed when the bidders stop bidding a higher price or for other reasons as well. The Dutch auction is another type of auction in which the seller offers an initial price and lowers the price until the good or service is sold. Another type of auction is referred to as a first-price-sealed-bid auction during which a single bid is made by all of the bidders and the highest bidder wins. Yet another type of auction is second-price sealed-bid auction, in which the highest bidder (and thus winner) pays what the second highest bidder had bid.

### SUMMARY

In one aspect, there is provided a method. The method may include selecting, by a user equipment, an establishment participating in an auction for a reservation of a table made available by the establishment; receiving, by the user equipment, bid information including at least one of a current bid or a minimum bid for the auction for the reservation of the table, when the auction begins; sending, by the user equipment, a bid to an auction system, the bid sent in response to the receiving bid information; and receiving, by the user equipment, an indication provided by the auction system, the indication representative of whether the user equipment won or lost the auction for the reservation of the table.

Implementations of the current subject matter can include, but are not limited to, systems and methods consistent including one or more features are described as well as articles that comprise a tangibly embodied machine-readable medium operable to cause one or more machines (for example, computers, and the like.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (for example the Internet, a wireless wide area network, a local area network, a wide area network, a wired network, or the like), via a direct connection between one or more of the multiple computing systems, and the like

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system for auctioning a limited resource, such as a table at a restaurant; and

FIGS. 2A-2B depict example processes, in accordance with some example implementations;

FIGS. 3A-3K depict example views or pages presented on a user equipment, such as a smartphone, tablet, and the like, in accordance with some example implementations;

FIG. 4 depicts another example of a system for auctioning a limited resource, such as a table at a restaurant; and

FIGS. 5-6 depict example processes, in accordance with some example implementations.

When practical, similar reference numbers denote similar structures, features, or elements.

### DETAILED DESCRIPTION

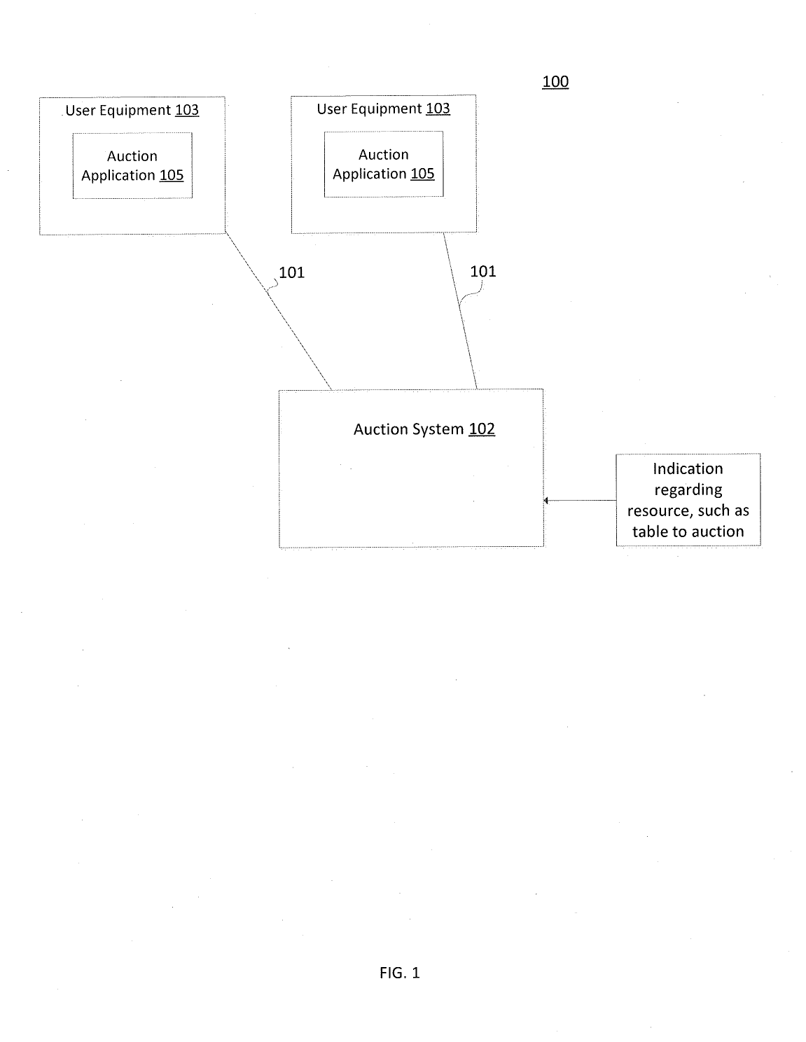

FIG. 1 depicts an example system 100, in accordance with some example implementations. System 100 may include one or more user equipment, such as user equipment 103. User equipment 103 may be implemented as a processor-based device, such a cell phone, a smartphone, a tablet-based computer, and/or any other processor-based device. User equipment 103 may further include a user interface, such as a keyboard, a touch sensitive screen, and/or any other user interface mechanism. User equipment 103 may also include an auction application 105, which may be downloaded from a website or other location to the user equipment 103. The user equipment 103 may couple via wired and/or wireless networks 101 to an auction system 102. Auction system 102 may include one or more processors and memory configured to provide an auction for a resource, such as an item, a service, a table, a ticket, a customer reservation, a place in a queue, and the like.

In some example implementations, user equipment 103 may access mobile auction application 105. Mobile auction application 103 may be configured to allow user equipment to bid on an auction for a resource. For example, a user of user equipment 103 may want to obtain a reservation for a table at a restaurant or other establishment. However, the restaurant/establishment may be oversubscribed, so the demand for reservations exceeds the supply of reservations at a given time. When this is the case, the restaurant/establishment may auction via auction system 102 the limited availability resource, which in this example is a reservation for a table. Moreover, one or more users at one or more corresponding user equipment, such as user equipment 103, may via auction application 105 bid on the limited resource (for example, the reservation/table), rather than wait a substantial amount of time for the resource (for example, the table or reservation). As such, the bidding user-patrons may benefit from obtaining, in this example, a table despite long waits, and the establishment auctioning the table/reservation may obtain additional revenue from the table/reservation, when compared to giving the table to any patron without requiring a minimum expenditure while using the table/reservation.

To illustrate with the restaurant example, the restaurant may only have a single table available for a 9 PM seating. Rather than give the reservation to anyone without regard to how much a party will pay, the restaurant may offer the table via auction system 102. Specifically, the auction system 102 may advertise that the table (or a reservation for that table) is being auctioned, receive bids from one or more user equipment, select a winning bid, and then provide the table to the winner.

In some implementations, the bids represent a guaranteed minimum that the party at a given user equipment promises to pay in exchange for the table. For example, auction system 102 may start the auction with an initial bid of $500 for the table at 9 PM, if multiple bids are received from user equipment participating in the auction, the auction system 102 may solicit higher bids and/or select a winning bid (for example, the user equipment offering to pay the most for the table), although other types of auctions may be implemented as well including a Dutch auction. In the case of a Dutch auction, bidding may start at an initial $500 and reduced until a bidder accepts the bid of a minimum bid is reached. The bidding process may repeat (for example, receive bids from user equipment, select a winning bid, and so forth). In some example implementations, the auction system 102 may thus allow an establishment, such as a restaurant or other entity, to obtain a guaranteed minimum revenue for a limited (and thus valued) resource, which in the previous example is a table reservation at 9 PM.

Although the previous example and some of the examples herein refer to auctioning a table or a reservation for the table, any resource, such as a ticket for a movie, access to an amusement park ride, a spot in a queue (for example, the front of the line or bypassing the queue altogether), and the like may be auctioned as well. Moreover, establishments other than restaurants may provide resources for the auction as well.

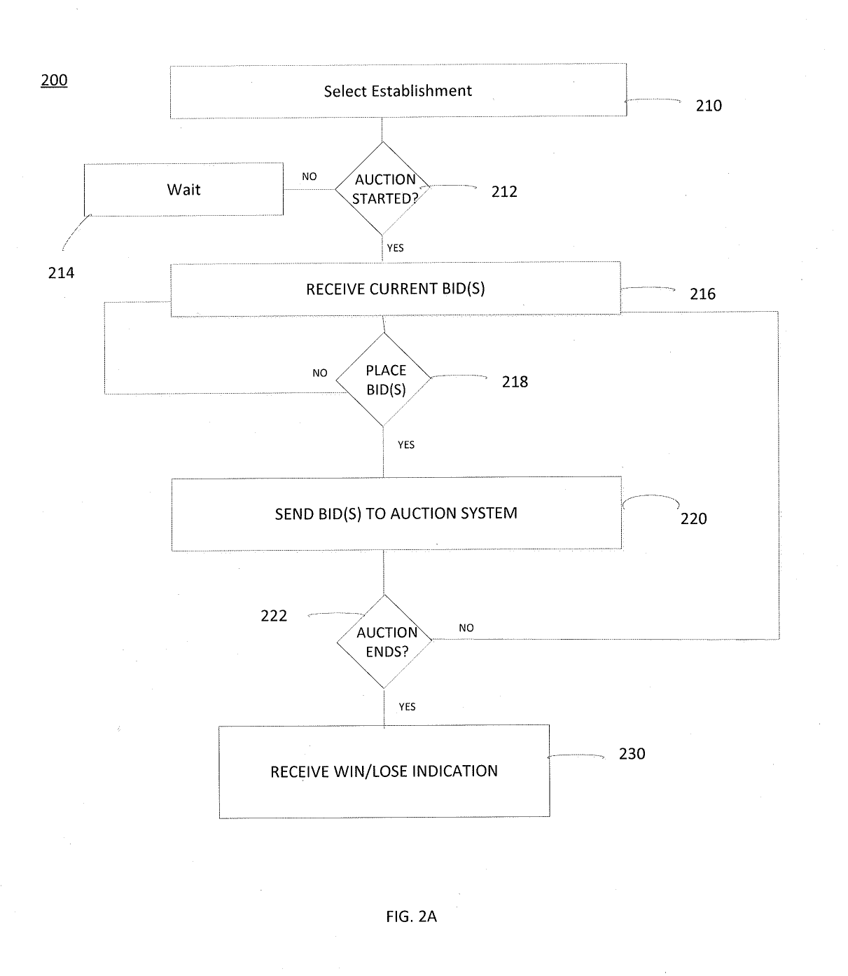

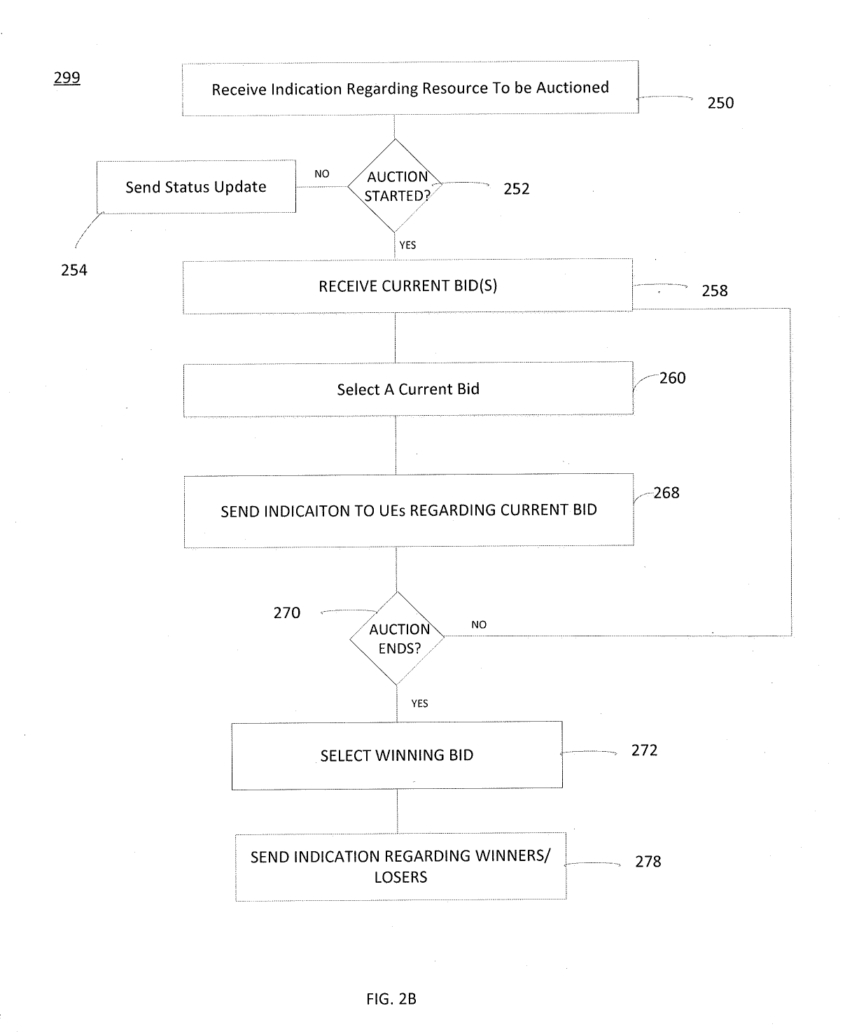

FIG. 2A depicts an example process 200 which may be implemented at a user equipment for auctioning a resource, such as a reservation for a table, a ticket, and/or the like.

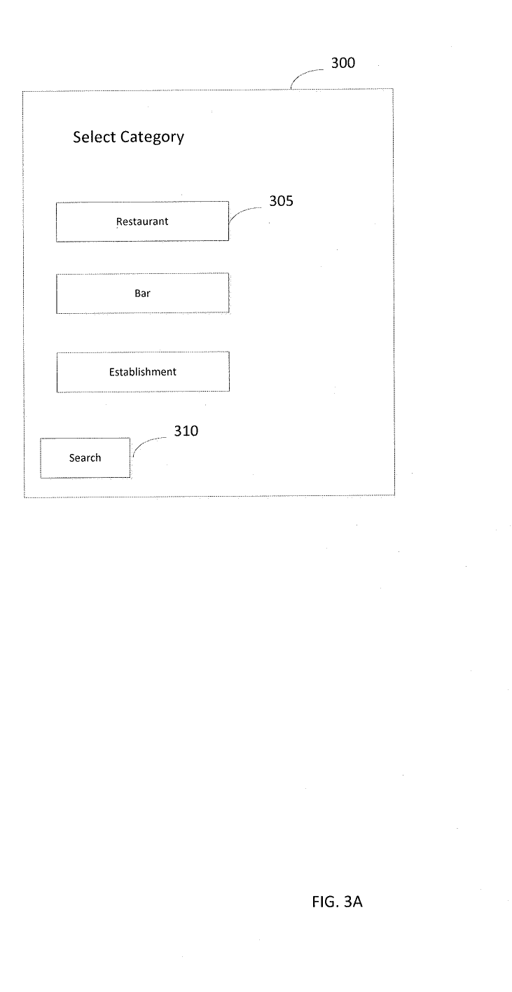

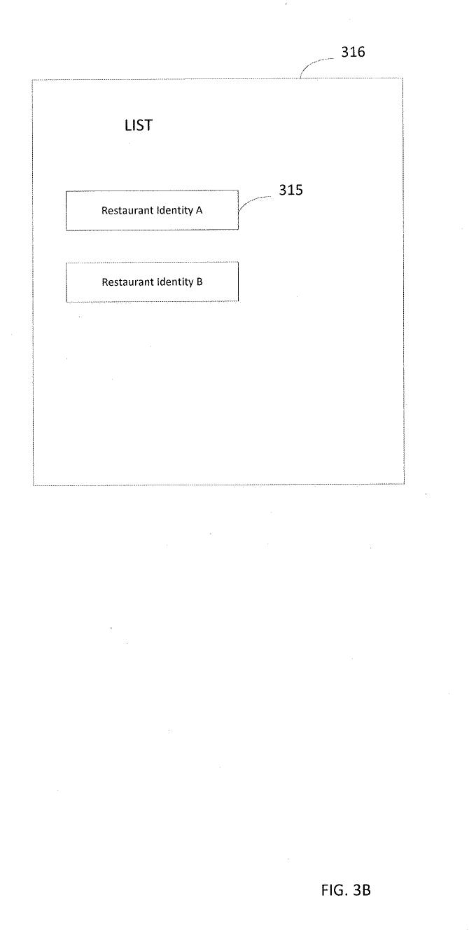

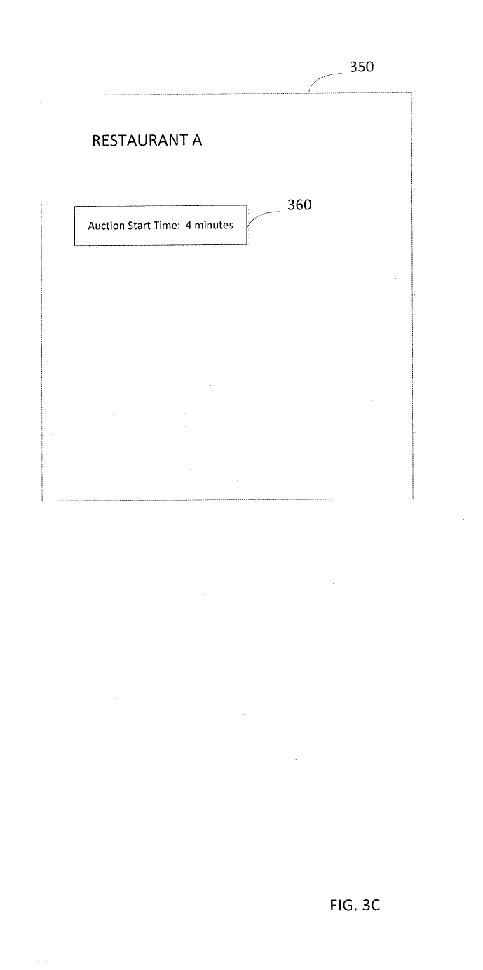

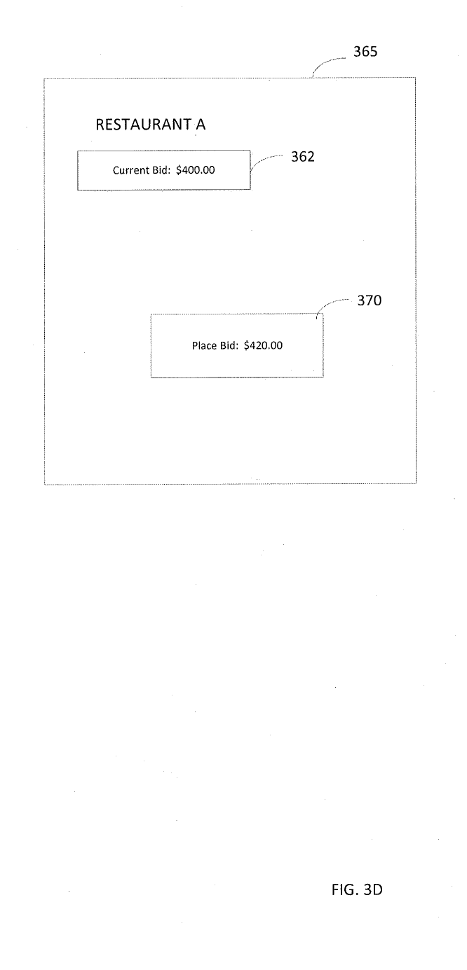

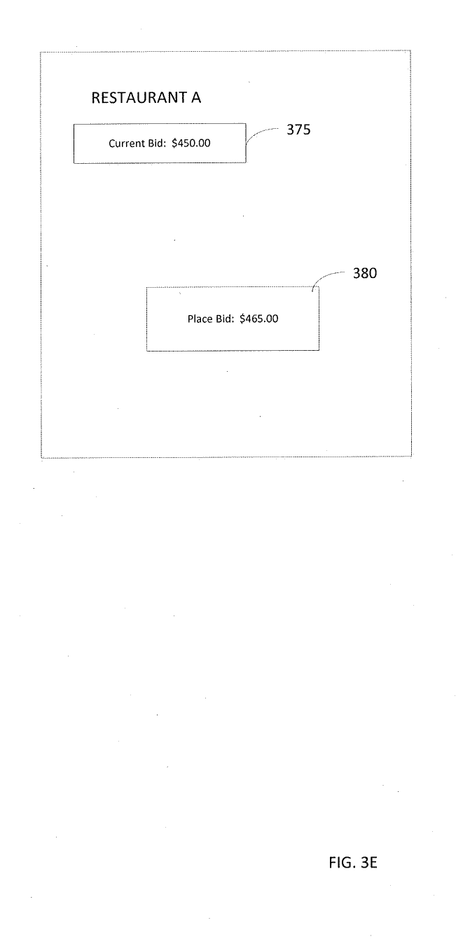

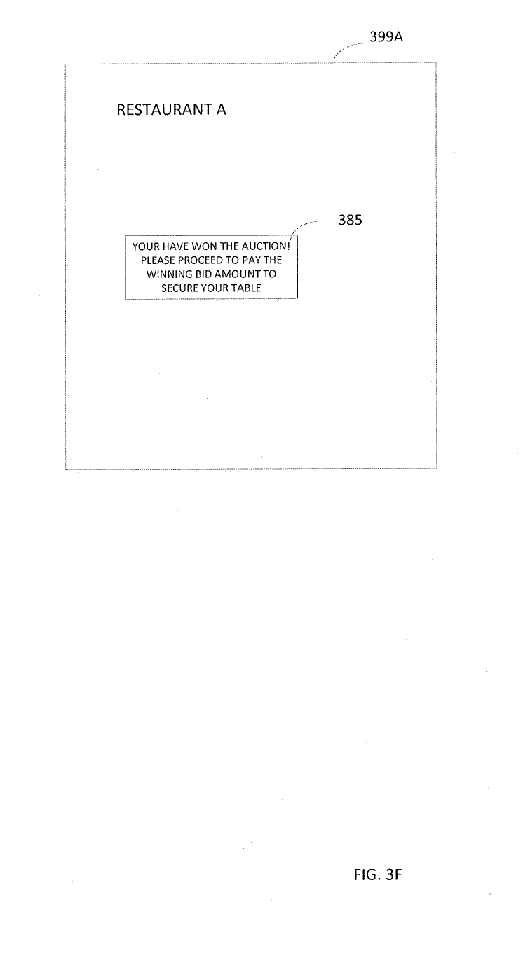

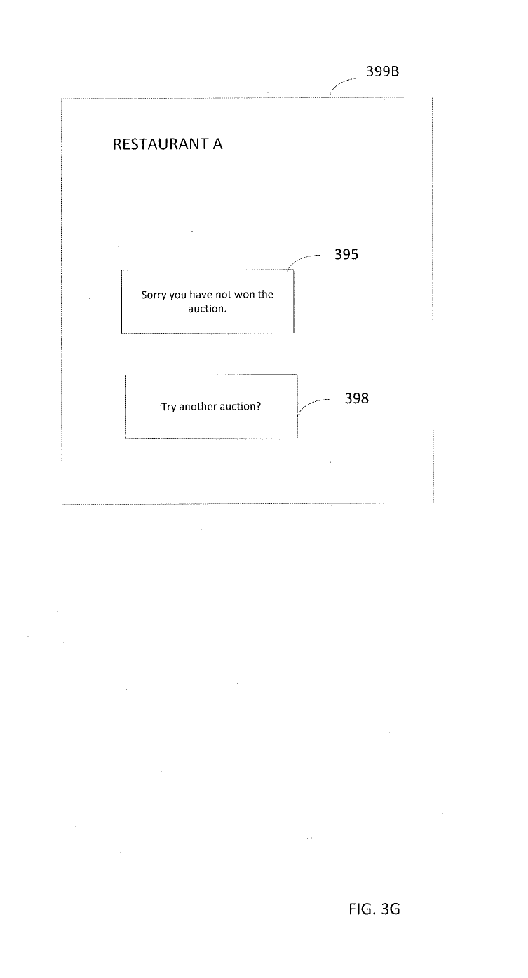

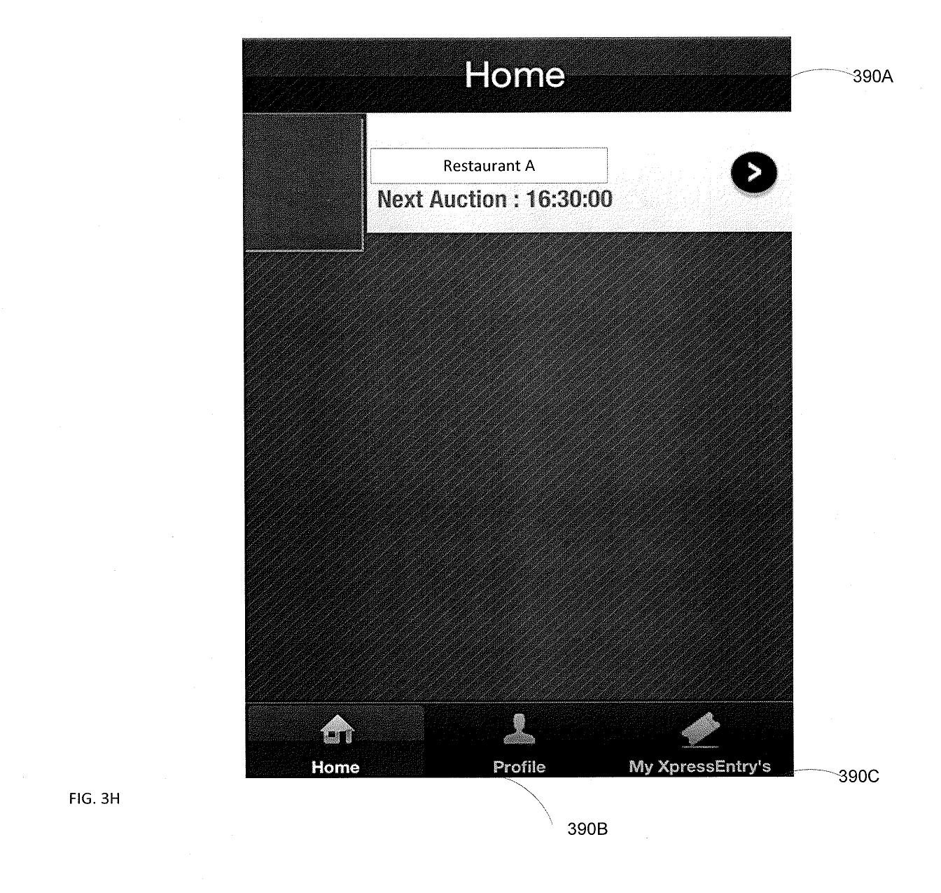

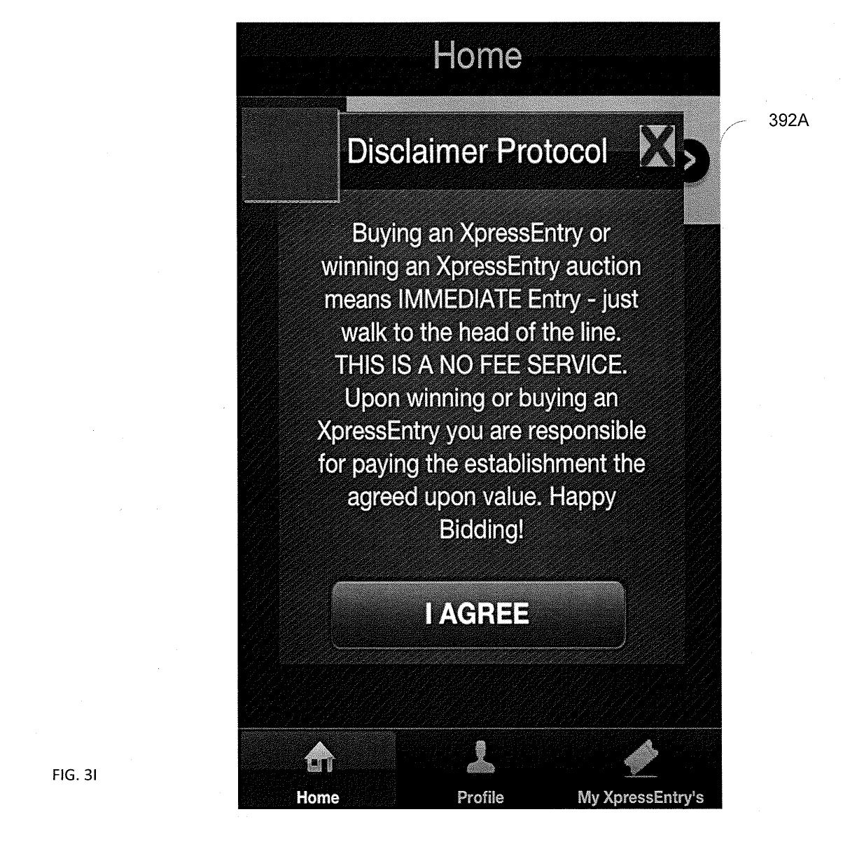

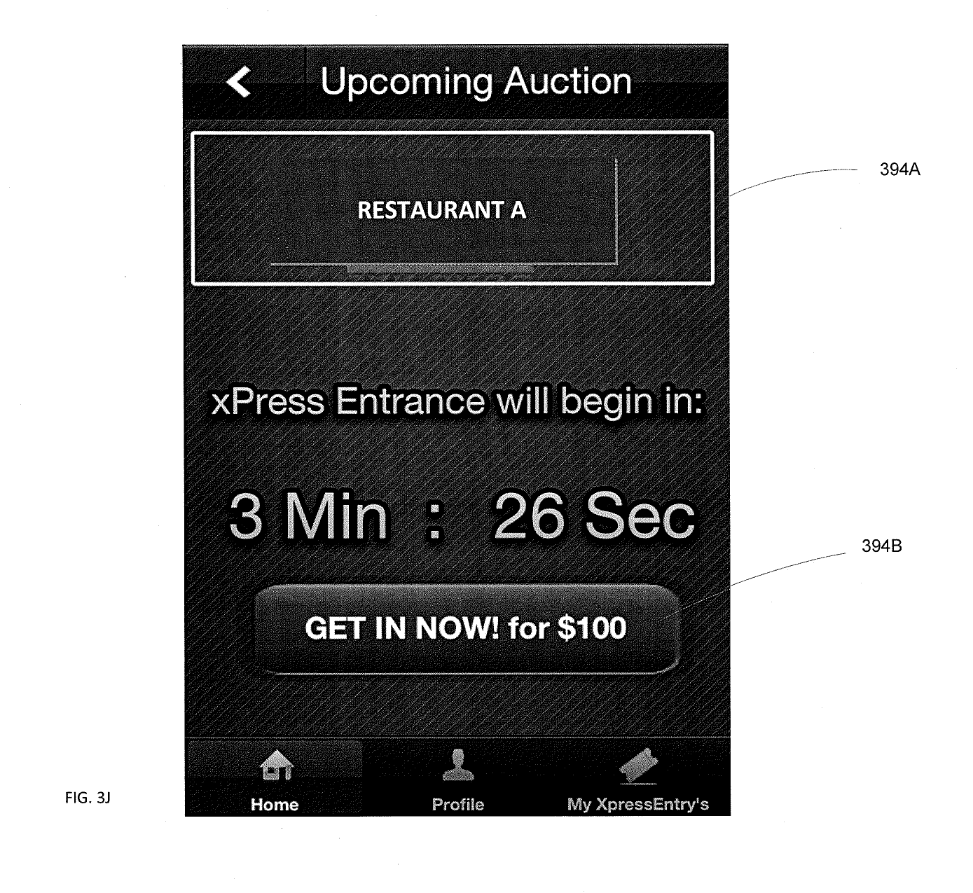

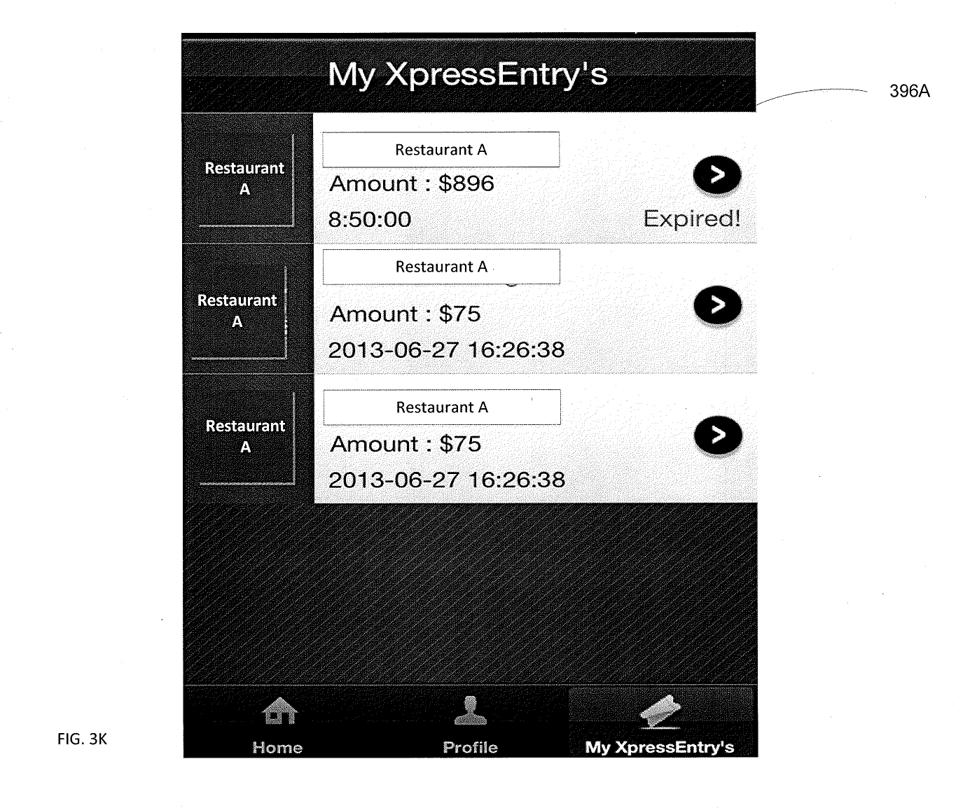

At 210, user equipment 103 may select an establishment to bid on a resource. For example, auction application 105 may enable searching for and selecting an establishment to identify whether a resource is being auctioned by the establishment. Referring to FIG. 3A-3B, auction application 105 may allow selecting categories of establishments (for example, bars, restaurants, clubs, and the like) or specific establishments, such a Restaurant A, B, or C. The auction application may also initiate a search for an establishment to identify whether a resource is being auctioned by the establishment (for example, based on location). Although user equipment 103 may search for auctions, the availability of auctions may also be pushed to the user equipment by a device, such as the auction system 102 as well.

FIGS. 3A-3J represent pages generated by for example auction system 102 and presented by a user interface at user equipment 103, although the generation and presentation may occur at other devices as well. In the example of FIG. 3A, selecting restaurant 305 at page 300 causes auction application 105 to send an indication of the selection to auction system 102. In response, user equipment receives page 316 (FIG. 3B), and selection of Restaurant A at 315 further initiates auction application 105 to send an indication to auction system 102, which responds with page 350 (FIG. 3C) if the auction has not started or page 365 (FIG. 3D) if the auction has started.

If the auction has not begun, user equipment 103 including auction application 105 may wait (no at 212 and 214) until the start of the auction. As noted, FIG. 3C depicts page 350 presented at a user interface at user equipment 103. Page 350 shows when the bidding is expected to begin page 360 for Restaurant A selected at 210 and FIG. 3B.

However, when the auction starts (yes at 212 and 216), the user equipment 103 including auction application 105 may receive a bid, such as an initial bid or a current bid. The initial bid may represent a bid set by the auction system at the start of the auction. This initial bid may correspond to a minimum the auction system will accept for the item being auctioned, or it may represent a starting bid as well. The current bid may represent a prior bid offered by a user equipment/auction application. The minimum bid may or may not be known to the bidders, and the minimum may set by the establishment auctioning for example a table reservation, although this minimum may be set by other mechanisms or entities as well. For example, page 365 at FIG. 3D depicts an example where Restaurant A is selected and a current bid 362 is presented. If a bid is placed at 370 at FIG. 3D, the bid is sent to auction system 102 for comparison to other received bids. In the example of FIG. 3D, a current bid of $400 is presented at 362 if user equipment places a bid 370 (which may include providing a dollar amount or merely selecting place bid which may be configured to send a bid at a predetermined amount higher (or lower if a Dutch auction) than the current bid of $400 to the auction system). FIG. 3E shows the bidding process after a different round of bidding. In this example, the current bid for the resource is $450 as shown at 375. The user equipment may choose to place a bid at 380.

If the user equipment does not place bid, the user equipment 103 may continue to receive bids (no at 218 and 216). For example, auction system 102 may continue to update the status of the auction and refresh the current bid amount at 360. However, if the user equipment places a bid (for example, a user selects 370 at page 365), the bid is sent to auction system 102 (yes at 218 and 220).

While the auction is in progress, the process at 216-222 may repeat (no at 222). However, if the auction ends, the auction system 102 may notify the bidding user equipment, which receive a message from the auction system indicating the winning or losing bid (yes at 222 and 230). For example, auction application 103 may present a message indicating that the user equipment 102 has won the auction and payment is required in order to keep the auctioned resource, such as a table seating at 9 PM. FIG. 3F depicts an example of a page 399A containing the winning indication. The auction system 102 and/or auction application 105 may also provide losing bidders with an indication of loss as well, such as the indication presented at page 399B at FIG. 3G. The loser may be allowed to try another auction by selecting 398.

FIG. 3H represents another page 390A, which can be presented at user equipment 103. Page 390A is similar to page 350 in some respects but further includes a user profile tab 390B where a user registered with the auction system 102 can provide preferences, such as preferred locations, restaurant types, credit card information, and the like. Tab 392C represents passes that a winner has earned by winning auctions. It shows the time, date, winning amount, and expiration time for pass. FIG. 31 represents another page 392A, which can be presented at user equipment 103. Page 392A includes information that a winning bidder is responsible for paying the establishment offering the resource being bid on. FIG. 3J depicts page 394A which is similar to page 350 in some respects but further includes a “Get In Now!” element 394B. When element 394B, the bidder can bypass the auction process and immediately obtain the resource, which in this example refers to immediate entry into the establishment. FIG. 3K depicts page 396A. Page 396A represents passes that have been won by either an auction or a Get it Now selection. Each pass may correspond to different establishments but are local to the user and/or phone. Passes may be owned by the user but will expire according to auction terms, which may be configured/set by establishment. The passes may be used to control access by for example setting an expiration time for the passes.

The auction system 102 may select the winning bid based on one or more factors. For example, the winning bid may be selected based on the amount bid. For example, if three bids are received, the highest dollar bid may be selected by the auction system 102 as the winner. However, other factors may be considered as well. For example, a point system may be used as well. For example, an affinity program may provide points that have an effective value. In this example, the points may be used for bidding. To illustrate, a restaurant or other establishment may have a frequent dinner program assigning points based on frequency of visits and/or amount spent. In this example, points may be used instead of, or in addition to, a dollar amount. Although the previous example describes bidding with dollars and points, other items of value may be used as well.

FIG. 2B depicts another example process 299, which may be implemented at the auction system 102.

At 250, the auction system 102 may receive a message indicating that an establishment is registering a resource, such as a table and the like, to be auctioned as a limited resource. For example, a message may be sent by a processor at an establishment, and this message may list a reservation/table to be auctioned at a given time.

If the auction has not started, the auction system 102 may send indications, such as messages, to one or more user equipment 103 regarding the status of the auction (no at 252 and 254). For example, page 350 (or a portion thereof) may be sent to user equipment 103. The indication may also be broadcast as an announcement or advertisement of the upcoming auction for a given resource.

When the auction starts, the auction system 102 may receive one or more bids at 258. For example, a user equipment 103 may place a bid by for example selecting place bid at 370 at page 365 presented at user equipment 103. The bid may comprise a dollar amount, although other types of bid may be placed as well.

At 260, the auction system 102 may select one of the bids, such as the highest valued bid as a current bid. The selected bid may then be sent, at 268, to one or more user equipment 103 registered for, or monitoring, the auction to inform the bidders or potential bidders. For example, the auction system 102 may send the select bid for presentation at 360 at page 365 presented on the user equipment 103 of the bidders. As noted, in some implementations, the auction system 102 may send an initial bid to begin the auction process.

If the auction has not ended, process 258-270 may repeat. However, when the auction ends at 270, the auction system 102 may select a winner at 272. For example, the auction system 102 may select the highest valued bid as the winner. Moreover, the auction system may notify, at 278, the winning and losing bidders by for example sending an indication, such as a message at 385 (FIG. 3F) and message 395 (FIG. 3G).

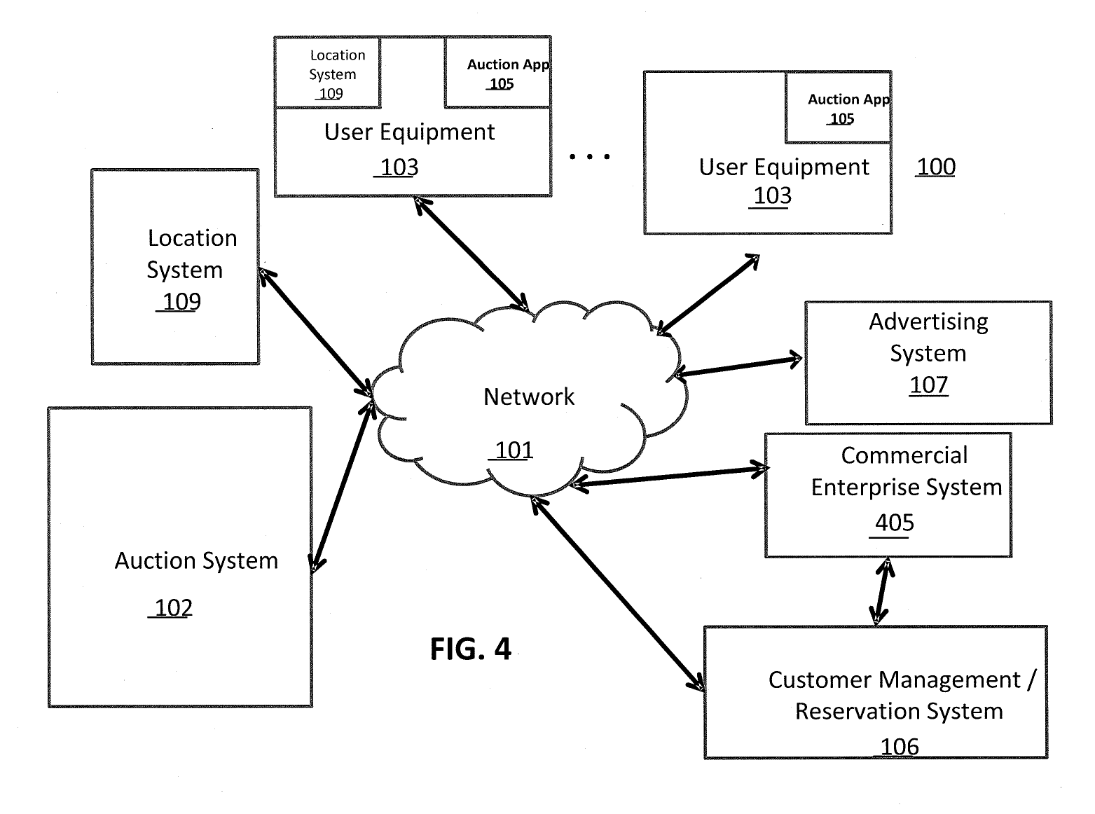

FIG. 4 depicts an example system 400 including one or more user equipment 103. The user equipment 103 may include an auction application 105 and other functions, such as an auction application and/or a geo-positioning (or location) system 109. The system 400 may also include an auction system 102, a commercial entity's enterprise system 405 such as the information technology system used by an entity, customer management/reservation system 106 used by an entity to manage customers and/or their reservations, and/or an advertisement system 107. Moreover, these physical devices 102-109 may be coupled by network 101.

The user equipment 103 may include at least one processor and at least one computer-readable storage medium. Moreover, the computer-readable storage medium may include code to configured the user equipment 103 including auction application 103 to provide one or more operations disclosed herein with respect to the use equipment (for example, select an establishment, receive current bids, send bids, present pages at a user interface, and/or accept payment). The user equipment 103 may also include a network interface to allow wired and/or wireless access to network 101. The wireless access may comprise for example access to wireless local area networks (for example, WiFi), cellular access, Bluetooth, and/or any other wireless access. As noted, examples of user equipment include a tablet computer, a smartphone, a computer with a wireless dongle, and the like. The user equipment 103 may also include a user interface, such as one or more of a keypad, a display, a touch screen, a microphone, a speaker, a browser, and the like. The user equipment 103 may access via network 101 other devices depicted at system 100 in order to, for example, communicate bids, make selections, and the like.

The auction system 102 may control auction tasks and communications to the user equipment 103. For example, auction system 102 may perform initiate, monitor, and/or determine a winner of an auction as described further herein. The auction system 102 may include at least one processor and at least one computer-readable medium, and may be implemented as a standalone system responsible the auction mechanisms disclosed herein or as a part of a larger system used for customer reservations, management, payments, and/or any other systems. Moreover, auction system's computer-readable storage medium may include code to configured the auction system 102 may provide one or more operations disclosed herein with respect to the auction system (for example, receive indications/messages regarding a resource to be auctioned, send status updates to user equipment, start auction, receive bids, send bid information to user equipment, select a winning bid, notify winners/losers, and/or accept payment).

The user equipment 103 may include, or be coupled to, a location system 109. The location system 109 may provide user equipment 103 and auction system 102 with a location of the user equipment 103. This location information may allow the auction system 102 to determine whether user equipment 103 is participating in the correct auction. For example, if the user equipment 103 provides location information representative of a location in San Diego, the auction system 103 may ensure that the current auction being processed for the user equipment 103 takes place in the San Diego location. Indeed, many restaurants have similar names, appearances, and the like, so the location information may enable the auction system 102 to validate and confirm that the user equipment is in proximity of the restaurant which is the subject of the auction. If a location system is not available (for example, global positioning system signal cannot be received indoors), the user may enter a provided password or a pass phrase to ensure the correct location of the auction. For example, the restaurant may have a monitor, a display/or a sign with a word displayed that must be entered at the device 103 to participate in the auction. This may ensure the user is participating in the correct auction (e.g., the correct physical location of a chain restaurant) and may prevent fraud (or persons not actually at the participating restaurant).

In some implementation of the location system, it uses a visual cue or pass phrase that the user must communicate to the auction system 102 through the user equipment to ensure proximity to an auction.

In some implementation of the location system, it may be used to generally search for auctions which are available for bidding in the location determined by the location system for the user equipment.

The commercial entity's enterprise system 405 and the customer management system 106 may be implemented as business systems including at least one processor and at least one computer-readable medium. The commercial entity's enterprise system 405 may provide a web portal for payment processing, vendor tracking, invoicing, and accounting information for the commercial enterprise, such as a restaurant, an amusement park, theatre, and/or any other venue or business.

Moreover, the commercial enterprise system 105 may be coupled to a customer management system 106 to track the loyalty and patronage of customers, the utilization of the businesses services, make reservations for the businesses services (for example, restaurant reservations), and the like. For example, customer management system 106 may provide computer-based reservations systems, customer tracking systems, and loyalty programs issued by commercial enterprises.

The following provides an example implementation of system 100. Upon arrival to a business, such as a restaurant and the like, the business may ask whether a user/customer would like to participate in an auction, such as a Dutch auction or any other type of auction, for accelerated access to the service offered by the business, such as a restaurant reservation. Although some of the examples described herein refer to using the auction for a restaurant reservation, the auction may be used for any other service, such as a bar, entry to a venue/concert, an amusement park ride (for example, the auction may be used to jump to the front of the line or to access a priority line for the ride), and the like. When the user/customer agrees, the business may provide the user/customer with a handheld wireless device, which may be implemented as user equipment 103. In this example, the user equipment 103 may be implemented as noted above, or may be implemented in other forms. For example, user equipment 103 may be a device with a user interface including one or more key pad buttons (for example, in the middle of the device or include multiple buttons) and a small display screen for communication with the user/customer. The user equipment 103 may also have a feedback mechanism (for example, vibration, flashing lights, and the like) indicating whether an input has been entered (for example, button pushed or signal sent) and/or the auction system 102 has transmitted information back to the user equipment 103. Although the display may be located on the user equipment 103, the display may also be located at other locations as well. For example, the display may be separate from the user equipment 103 and within view of the user/customer. Moreover, this display may present information regarding the status of the auction, and this presented information may be provided by the auction system 102 and/or user equipment 103. This information may also be configurable by the business, such as the restaurant. This information may include information representative of the service being auctioned (for example, a restaurant reservation and the like) as well as other information, such as sales, promotions, external advertisements, or anything else the business wishes to transmit to the user/customer.

In some implementations, auction system 102 may receive information from the commercial entity's enterprise system 405 and/or customer management/reservation system 106. For example, the received information may represent a manual triggering of an auction, a timed triggering of an auction, a volume related trigger, and/or an indication that a resource, such as a table and the like is available for auction. The auction system 102 may then notify user/customer of user equipment 103 with a message (for example, an SMS text, an email, and other electronic messaging mechanism), visual cues (for example, lights, messages on screen, and the like), audio cues (for example, noise, beep, message, and the like), and/or haptic cues (for example, vibration) that an auction will take place. The auction system 102 may then begin the auction at a first value, such as a value selected by the business offering the service. The first value is then sent by auction system 102 to the one or more user/customers at one or more user equipment 103 as an offer, and if accepted, the user/customer may then be scheduled for the service. Once the auction begins, the auction system 102 monitors all of the user equipment 103 for an indication (for example, a message) of acceptance of the first value offered to the user/customers. If the auction system 102 receives an indication that the first value offered for the service has been accepted by a user/customer at one of the user equipment 103, the auction may be suspended, while the service is then offered to the user/customer accepting the offer, and all other devices 103 may be disabled from participating in the auction. The auction system 102 may display information identifying the winner (for example, a device number, a user name, and the like) on a display screen and/or trigger the user equipment 103 to provide feedback to the holder/winner of the user equipment 103. In implementations where the user equipment is provided specifically for the auction, the winning user/customer may return user equipment 103 to commercial enterprise, make payment, and proceed to use the auctioned resource (for example, a table, reservation, and the like) at the agreed upon winning price. All others holding non-winning user equipment/devices may continue to hold onto their user equipment/devices for another auction.

To illustrate with another example, a customer may enter into a restaurant and may be informed that there is a 45 minute wait for service. The customer may be given a user equipment configured as a pager-like device that will notify the customer when a table is ready or invited to use their personally owned user equipment device with an auction application designed to interface with the restaurant's system(s). Although user equipment may include a display, a second display may be positioned in view (for example, on a wall behind a ticket or hostess stand) so that the customer/user can see the display while waiting for a table, and this display may present information about the restaurant (for example, ads, menu, specials, and the like). At a predetermined interval of time, the hostess may initiate an auction controlled by auction system 102. The monitor may inform the customer of the auction and information about the table that is up for auction, such as a quantity of people that can be seated during at the table, a location of the table (for example, ocean view, kitchen view, and the like), and any other information the restaurant may want to present. The one or more user equipment 103 in the restaurant may provide an indication (for example, a buzz, flashing light, sound, and the like) to the customer(s) that the auction is taking place, and, if equipped, the user equipment may present auction information on a display screen. The auction may then be conducted with a first price for the service. This first price may be broadcast to one or more user equipment, and decrease (for example, at predetermined intervals) until a customer indicates an acceptance of the offer price (for example, by pressing a button on the pager-like device/user equipment). The winning pager-like device/user equipment may also provide an indication, such as a flash or a vibration, representative of a winning bid and acceptance of the offer price for the table. The pager-like device/user equipment may be returned to the hostess and the customer may pay the agreed upon offer price set by the auction. The use of the auction does not necessarily require the winner to pay the winner an amount in a monetary currency. Rather the auction could set a minimum level of services to be rendered (for example, setting a table minimum where the patron has to spend the winning amount) or a closed currency system (for example, redeem loyalty points) to pay for the auction. The auction may not have to indicate that something is being paid for. Rather, the auction could establish a table minimum or an extra service. In some implementations, the user/customer may redeem points instead of cash for payment of the table being auctioned.

In some implementations, the user equipment may communicate wirelessly in substantially real time. In this implementation, the customer may arrive at the business establishment, such as a restaurant, and is informed there is a delay in the ability of the business to provide the service, such as a table at the restaurant. The customer may be identified in the customer management system 106 and a reservation for the table is added. The customer management system 106 may track the customer's patronage of the establishment and may have an account for the customer to allow providing the customer with “points” for the frequency of visits, the dollar amount spent, and the like. The customer may be prompted to access additional information about the business, including the possibility of accelerated service via the auction disclosed herein via a display (for example, a monitor) in view of the customer (for example, near the hostess stand and controlled by the commercial entity's enterprise system 405). Furthermore, the customer may be prompted to connect to the commercial entity's enterprise system 405 with a device, such as user equipment 103, by visiting a webpage and/or downloading an application.

The location system 109 may also assist the customer when accessing the correct information for the business and its corresponding commercial entity's enterprise system 405. The location system 109 may be triggered by the customer or the commercial entity's enterprise system 405 to determine a current location of the customer and the corresponding user equipment. Once the customer has connected to the commercial entity's enterprise system 405 and the correct location for the user equipment has been identified, information about the business may be presented to the customer including the option to participate in the auction for the service, such as a table in the case of a restaurant. The customer management system 106 may be configured to alert the commercial entity's enterprise system 405 that an auction may be pre-configured based upon the number of customers on the reservation list, the current time wait for a reservation, a preset time interval, or by the business itself. For example, the commercial enterprise system and/or customer management system may be programmed that once the reservation list reaches a preset number of patrons waiting or the estimated wait time exceeds a preset interval the system automatically triggers an auction.

The customers currently connected to the commercial entity's enterprise system 405 may receive information representative of the pending auction and may prompt the customer whether they would like to participate in the auction. If so, the customer may be connected to the auction system 102. If the customer does not want to participate in the auction, the customer may continue to send and receive information from the commercial entity's enterprise system 405. Once the customers wishing to participate in the auction have been connected to the auction system 102, the auction system 102 may begin the auction and may query the customer management system 106 to see if there are any customers with prior patronage or have a points balance. The points balance may be displayed for those customers that have available points. For customers without points, a zero balance is displayed.

The auction system 102 may provide information about the service on which the customers are bidding and this information may be presented on a display. After a preset interval of time (or when a certain amount of bidders respond regarding interest on the auction), the auction may begin. After one or more customers win the auction, the winner(s) and/or loser(s) may be notified (for example, with a message displayed on a screen). The losers may be asked if they would like to participate in another auction. If so, the losers may be added to the next auction conducted by auction system 102. The auction system 102 may transmit information to the customer management 106 system. The customer management 106 may move a reservation for the winning auctioned service to the front of the queue for the service. If points are used, the points will be deducted from the customers points balance. If the auction has set a minimum for the price of the service, the commercial entity's enterprise system 405 may ensure that the service price meets the threshold. If points were not used and the consumer agreed to pay a fee for the accelerated service, the customer will be invoiced via the commercial entity's enterprise system 405, and the user equipment may disconnect from the commercial entity's enterprise system 405.

To illustrate further, a customer approaches a night club and is told there is an hour wait and must wait in line. Outside of the night club is a monitor displaying information about the club (specials, events, promotions, and the like) to the patrons waiting in line. The monitor provides information for patrons to connect to the business through a website or an application. The customer in line may use their user equipment, such as a smart phone, and download the night club's application (or opens the application if they had already done so) or connect to the establishment's computer servers and/or services. Upon opening the auction application, the customer uses the location system to determine which night club they are at or search for and select the location manually. Additionally, if the customer has established a relationship with the business, the customer may enter a username and password to provide identification information to the business. The business may also use unique identifiers from the phone to identify the customer and track their patronage. As the customer is looking at the night club information on their smart phone, the customer may be asked if they would like to participate in an auction to set a bar minimum for that patron. Once the customer responds yes, the customers who have a relationship with the night club and participate in a loyalty points system will have their points displayed. Those who do not participate in the points system will show a zero balance. An auction begins at a preset condition (for example, time, saturation, number of patrons connected to auction system) and the first patron to trigger their device is the winner. Based upon the amount which the customer triggered the device, the amount from the winning auction may be automatically deducted from their points balance. Additionally, the customer can have their credit card charged through the online service, swiped at a physical reader within the location, or a tab can be opened in the nightclub with a minimum set for the tab correlating to the amount of the auction.

In some implementations, a customer faced with a long wait to enter an establishment, such as a restaurant, night club, bar and the like is able to download the auction application to participate in an auction to reduce the wait for a table or bypass the auction and the line with a “Get in Now” price. For example, if a current cover charge to enter a night club or venue is $10, an auction may be initiated every 15 minutes with the auction starting at $50 and terminating at $20. Additionally, during a time period between auctions, a “Get in Now” price of $75 may be offered to those not wishing to wait or participate in the auction. The winners of the auction or the Get in Now participants may pay by a variety of mechanisms, such via the user equipment/smart phone directly, paying the establishment (for example, showing an indication of winning an auction or paying the Get it Now price), and the like.

In some implementations, the location system 109 may be used to identify the patron's specific location and based upon that location, the business can offer the patron participation in an auction. A difference here is that the business offers the auction based upon the user's location, rather than the user equipment requesting participation in the auction. For example, the user equipment 103 including location system 109 may couple to auction system 102, commercial entity's enterprise system 405, and/or customer management/reservation system 106. In this example, the location system 109 may provide location information to allow the auction system 102, commercial entity's enterprise system 405 and/or customer management/reservation system 106 to determine whether a patron using the user equipment 103 is located in a predefined area. The auction system 102, commercial entity's enterprise system 405, customer management/reservation system 106, and/or other system may send customer reward balance information to user equipment 103 as well as information about a venue, such as an amusement park and the like. The user equipment 103 may track and send location information back to the auction system 102, commercial entity's enterprise system 405, and/or customer management/reservation system 106 as the patron moves (for example, within a given region, an amusement park, and/or the like). Once the patron enters a pre-established location (which may be proximate to, for example, a sensor or a predetermined GPS coordinate location a commercial entity's enterprise system 405, and the like), commercial entity's enterprise system (and/or auction system 102 and the like) may communicate to the user equipment the availability of the accelerated entry provided by the auction service disclosed herein, and query the patron to participate. The user, through the user equipment, can signal to the commercial entity's enterprise system the willingness to participate in the auction. The user equipment may then be connected to the auction system and, when triggered (for example, at a predetermined trigger time, number of users connected, or by the business itself), the auction will commence. The auction system 102 may pass the winning information to the commercial entity's enterprise system where the user's point balance may be deducted or credit card charged. The user equipment may then display a message to the user notifying them of their win. The user equipment may then display a message or bar code or send wireless signal to authenticate the user and device for accelerated/expedited entry.

The following illustrates another example. A customer walks into a venue, such as an amusement park, and launches an auction application on a user equipment, such as a smart phone. The auction application, through a location system tied to the park's commercial enterprise, identifies that the customer is inside the amusement park. The auction application may be associated with an account within the amusement park that tracks all spending within the park and creates a rewards balance. As the customer is moving through different areas, the auction application may track the location of the user equipment 103 carried by the customer and offer the ability to participate in auctions based upon the customer's location. For example, the customer may arrive at an attraction to discover there is a 1 hour wait to enter the attraction. While waiting in line or at the entrance of the attraction, the user may launch the auction application on the user equipment or smart phone and then use reward credits for immediate entry or be queried if they want to participate in an auction for immediate entry. When sufficient customers/users are connected to the auction system or at a predetermined interval, the auction system may be conducted with the connected customers/users. The winning customer/users may have their account balance reduced by a certain amount corresponding to the agreed price or points, and smart phone may display a message or a bar code to prevent fraud through verification that will allow for expedited entry into the venue.

Although the previous examples refer to specific examples, the systems and methods disclosed herein may be used in a variety of applications in which an entity is waiting in a queue for a service (for example, oil changed on car, security checkpoint at an airport, ticket booth line, and the like).

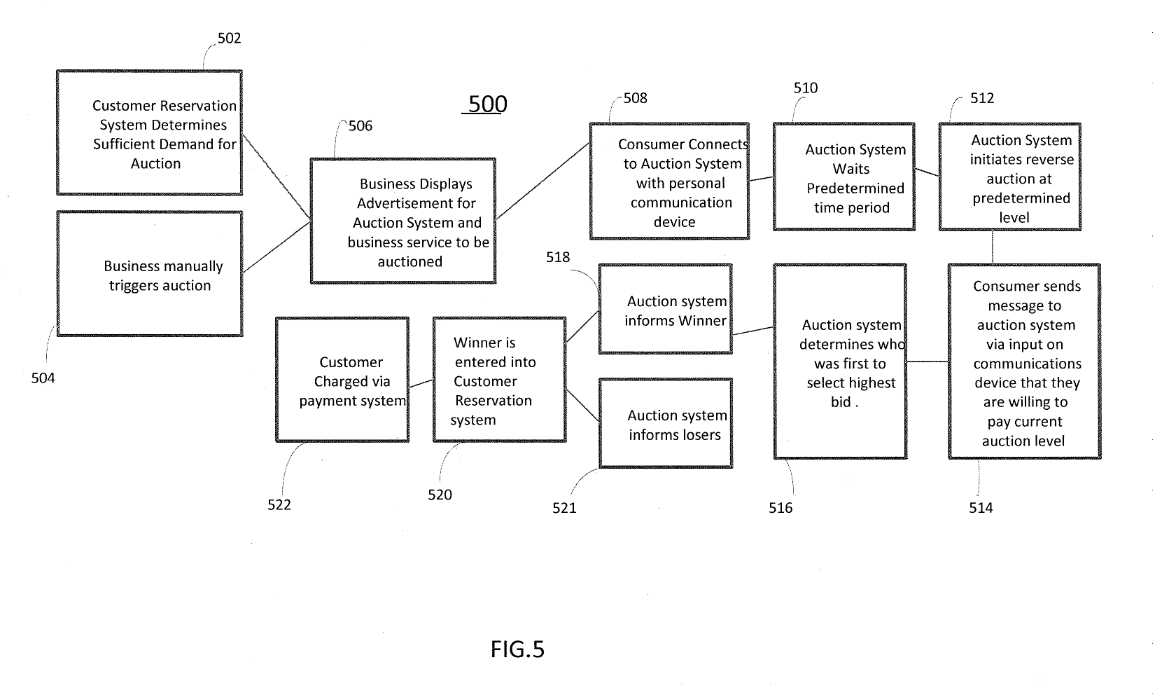

FIG. 5 depicts an example process 500 in accordance with some example implementations. The description of FIG. 5 also refers to FIG. 4.

At 502, the customer reservation system 106 may determine an auction is appropriate when for example there is sufficient demand for a resource, such as a table, a ticket, a reservation, and the like, and/or sufficient demand for an auction. For example, if there is a limited resource or a long wait and/or users have requested an auction, the customer reservation system 106 may trigger an auction by sending an indication to auction system 102 requesting an auction for a resource, such as a table, reservation, and the like. However, an enterprise, such as a restaurant or other entity, may also trigger the auction in a so-called manual way at 504 by simply sending a message to auction system 102 requesting an auction or by selecting an icon on a user interface at a computer and the like (which may also send an indication to auction system 102). At 506, the auction system 102 may generate a display or page for presentation that indicates that a resource, such as a table, a reservation for a table, a ticket, a service, and/or any other resource, is going to be auctioned. At 508, the user equipment of a given customer/consumer may couple to auction system 102 and wait at 510 a given time for the auction to begin. At 512, the auction system 102 may initiate an auction. This auction may be a Dutch auction, where a bid is set and lowered until a customer/consumer at a user equipment accepts at 514 the bid, although other types of auctions may be used as well. At 516, the auction system 102 may determine a winner, which may include determining which bid is highest and received first from a plurality of customers/consumers at a plurality of corresponding user equipment. At 518, auction system 102 may inform a winner by sending a message or a page of portion thereof for presentation at the user equipment to thus notify the winner. At 520 and 522, the auction system 102 may register the winning bidder (for example, the winner's user equipment or the identity of the winning bidder) into customer management/reservation system and may collect payment. For example, the winner may obtain a reservation in the customer management/reservation system for a table. At 521, the auction system 102 may also inform losers as well.

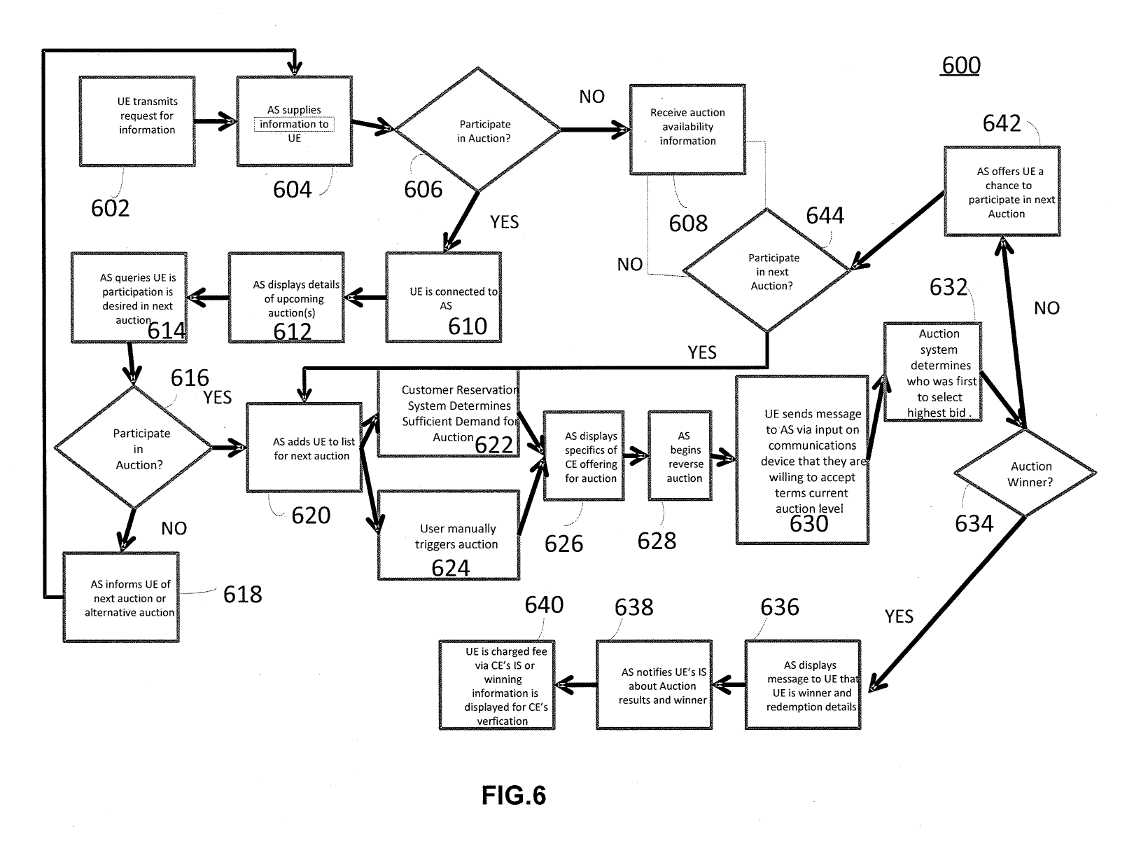

FIG. 6 depicts another example process 600 in accordance with some example implementations. The description of FIG. 6 also refers to FIG. 4.

At 602, a user equipment (UE) may transmit a request for information to an auction system. This request may inquire about whether a given entity participates in the auction process disclosed herein and/or whether one or more entities in a given area participate in the auction process disclosed herein. At 604, the auction system (labeled AS) may respond with the information requested at 602 including information identifying potential auctions (for example, a list of restaurants or other enterprises participating in the disclosed auction process). At 606, a decision may be made regarding whether to participate in an auction (for example, user equipment selects a given restaurant as depicted at 315 at FIG. 3B). If so (yes at 606), the user equipment may connect to the auction system, but if not (no at 606), the user equipment may continue to receive at 608 information regarding the availability of auctions at one or more enterprises and the like. At 612, the auction system may generate a display or page regarding the status of upcoming auctions. At 614, the auction system may query the user equipment regarding whether the user equipment wants to participate in an upcoming auction. At 616. If the user equipment chooses to participate in an auction, the auction system may inform the user equipment of an upcoming auction or other auctions as well.

At 644, if the user equipment participates in an upcoming auction, the auction system may add the user to an auction participant list. The auction system may initiate the auction at 622 and 624 (for example, initiated programmatically based on demand or other factors or initiated by the so-called manual trigger). At 626, the auction system may generate a page or display describing the details of the auction at a given commercial enterprise (CE), such as a restaurant, club, amusement park, and/or any other entity. At 628, the auction system may begin the auction, which may be in the form of a Dutch auction although other types of auction may be used as well. At 630, the user equipment may send a message to the auction system, and this message may represent that a bid is either placed or accepted. At 632, the auction system may select the first, highest bidder and declare a winner at 634. In some implementations, the winner at 634 may be selected after a given period of time (for example, the auction is open for a certain time period, although the winner 634 may be selected when the bidding meets a target price, received bids do not exceed a current bid, and/or any other factors. At 636 and 638, the auction system may send an indication to a user (or generate a display) regarding the identity of the winner (which may further include instruction on how to obtain the bid item). At 640, the user of the winning user equipment may pay for the bid item.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
selecting, by a user equipment, an establishment participating in an auction for a reservation of a table made available by the establishment;
receiving, by the user equipment, bid information including at least one of a current bid or a minimum bid for the auction for the reservation of the table, when the auction begins;
sending, by the user equipment, a bid to an auction system, the bid sent in response to the receiving bid information; and
receiving, by the user equipment, an indication provided by the auction system, the indication representative of whether the user equipment won or lost the auction for the reservation of the table.

2. The method of claim 1, wherein the bid represents a guaranteed minimum to be paid to the establishment when using the table at the establishment comprising at least one of a restaurant or a bar.

3. The method of claim 1, wherein the user equipment includes at least one of a processor-based device, a smartphone, and a computer.

4. The method of claim 1 further comprising:
presenting, at the user equipment, a page including the establishment, and wherein when the establishment is selected, another page is presented at the user equipment, the other page including at least one of information regarding when the auction will begin or the bid information.

5. The method of claim 1 further comprising:
receiving, at the auction system, available table information, wherein the available table information represents at least one table made available by the establishment for the auction.

6. The method of claim 1 further comprising:
initiating a search for establishments participating in auctions for reservations of tables.

7. The method of claim 1 further comprising:
sending, by the user equipment, a predetermined bid to the auction system, wherein the predetermined bid represents a predetermined amount at which the reservation of the table can be obtained.

8. The method of claim 1, wherein the indication further comprises table information and an expiration time to redeem the reservation for the table.

9. A system comprising:
at least one processor; and
at least one memory including code which when executed provides operations comprising:
selecting an establishment participating in an auction for a reservation of a table made available by the establishment;
receiving bid information including at least one of a current bid or a minimum bid for the auction for the reservation of the table, when the auction begins;
sending a bid to an auction system, the bid sent in response to the receiving bid information; and
receiving an indication provided by the auction system, the indication representative of whether a user equipment won or lost the auction for the reservation of the table.

10. The system of claim 9, wherein the bid represents a guaranteed minimum to be paid to the establishment when using the table at the establishment comprising at least one of a restaurant or a bar.

11. The system of claim 9 further comprising:
presenting a page including the establishment, and wherein when the establishment is selected, another page is presented including at least one of information regarding when the auction will begin or the bid information.

12. The system of claim 9 further comprising:
receiving, at the auction system, available table information, wherein the available table information represents at least one table made available by the establishment for the auction.

13. The system of claim 9 further comprising:
initiating a search for establishments participating in auctions for reservations of tables.

14. The system of claim 9 further comprising:
sending a predetermined bid to the auction system, wherein the predetermined bid represents a predetermined amount at which the reservation of the table can be obtained.

15. The system of claim 9, wherein the indication further comprises table information and an expiration time to redeem the reservation for the table.

16. A non-transitory computer readable storage medium including code when executed by at least one processor provides operations comprising:
selecting an establishment participating in an auction for a reservation of a table made available by the establishment;
receiving bid information including at least one of a current bid or a minimum bid for the auction for the reservation of the table, when the auction begins;
sending a bid to an auction system, the bid sent in response to the receiving bid information; and
receiving an indication provided by the auction system, the indication representative of whether a user equipment won or lost the auction for the reservation of the table.

17. The non-transitory computer readable storage medium of claim 16, wherein the bid represents a guaranteed minimum to be paid to the establishment when using the table at the establishment comprising at least one of a restaurant or a bar.

18. The non-transitory computer readable storage medium of claim 16 further comprising:
presenting a page including the establishment, and wherein when the establishment is selected, another page is presented including at least one of information regarding when the auction will begin or the bid information.

19. The non-transitory computer readable storage medium of claim 16 further comprising:
receiving, at the auction system, available table information, wherein the available table information represents at least one table made available by the establishment for the auction.

20. The non-transitory computer readable storage medium of claim 16 further comprising:
initiating a search for establishments participating in auctions for reservations of tables.
